(19) United States
(12) Patent Application Publication
(10) Pub. No.: US 2020/0307086 A1
(43) Pub. Date: Oct. 1, 2020

(54) OPTICAL POSITION SENSING SYSTEM

(71) Applicant: Hewlett-Packard Development Company, L.P., Spring, TX (US)

(72) Inventors: Mark Groenenboom, Sumner, WA (US); Joshua Coder, Vancouver, WA (US); Tait A. Regnier, Vancouver, WA (US)

(21) Appl. No.: 16/650,452

(22) PCT Filed: Nov. 18, 2017
(86) PCT No.: PCT/US2017/062437

§ 371 Date: Mar. 25, 2020

(51) Int. Cl. B29C 64/245; B33Y 30/00; G01D 5/347

(52) U.S. Cl. CPC B29C 64/245; G01D 5/34746; B33Y 30/00

(57) ABSTRACT

In one example, an optical position sensing system includes a linear encoder strip, an optical limit switch having an actuator on the encoder strip to activate the limit switch, and an optical reader to read the encoder strip.

### BACKGROUND

Additive manufacturing machines produce 3D (three-dimensional) objects by building up layers of material. Some additive manufacturing machines are commonly referred to as “3D printers.” 3D printers and other additive manufacturing machines make it possible to convert a digital representation of an object into the physical object. The digital representation may be processed into slices each defining that part of a layer or layers of build material to be formed into the object.

### DRAWINGS

FIG. 1 is a block diagram illustrating one example of a position sensing system such as might be used to help control the position of a build platform in an additive manufacturing machine.

FIG. 2 is a block diagram illustrating an example position sensing system from FIG. 1 implemented in a platform lift for an additive manufacturing machine.

FIGS. 3-6 are isometric and elevation views illustrating one example of a build unit for an additive manufacturing machine. FIGS. 3 and 4 show the unit with a build platform in a raised position. FIGS. 5 and 6 show the unit with the build platform in a lowered position.

FIGS. 7 and 8 are details from the example build unit shown in FIGS. 3 and 5, respectively.

FIG. 9 is an isometric detail view illustrating the example leadscrew drive assembly and guide rod bearing assemblies in the lift of FIGS. 3-6.

FIGS. 10-13 are detail views of the example leadscrew drive assembly shown in FIG. 9.

FIGS. 14 and 15 are detail views of the example guide rod bearing assemblies shown in FIG. 9.

The same part numbers designate the same or similar parts throughout the figures. The figures are not necessarily to scale.

### DESCRIPTION

In some additive manufacturing processes, heat is used to fuse together the particles in successive layers of a powdered build material to form a solid object. One of the challenges of additive manufacturing with powdered build materials is accurately lowering the build platform incrementally for each layer of build material. A build cycle may include hundreds or thousands of layers of build material each less than 100 microns thick, for example. A lift lowers the platform by the layer thickness for each succeeding layer of build material.

A new lift has been developed to help accurately and cost effectively lower a build platform in an additive manufacturing machine. In one example, a lift includes a rotationally stationary leadscrew to support a platform, a rotatable drive nut to drive the leadscrew up and down, an anti-backlash spring to apply a continuous downward force to the leadscrew, and a counter-balance spring to apply a continuous upward force to the leadscrew. As the leadscrew moves down to lower the platform, the downward force of the anti-backlash spring decreases and the upward force of the counter-balance spring increases to compensate for the weight of the build material added to the platform at each increment of lowering. The springs are designed so that, excluding forces exerted by the drive nut, the total downward forces acting on the leadscrew are always greater than the total upward forces acting on the leadscrew to inhibit backlash throughout a full range of motion of the leadscrew, and so that the net magnitude of the downward forces stays within a desired range. These features help maintain lower, more consistent forces in the lift drive system, thus enabling the use of less expensive components, a commodity leadscrew and plastic drive nut for example. Examples of the new lift are described in detail in international patent application no. PCT/US2017/039747 filed Jun. 28, 2017.

A linear encoder may be used as part of a position sensing system to help correctly position the build platform. Soft stops are desirable at upper and lower platform positions to minimize the occurrence of hard stops at the limits of travel. It has been discovered that inexpensive optical detectors do not detect the scale markings on a transparent encoder strip for a lift architecture such as that disclosed in the '9747 application referenced above. Consequently, instead of using separate actuators to activate the optical limit switches, the actuators may be part of the encoder strip itself, for example as opaque patches near the ends of the strip, eliminating separate actuators to help simplify the position sensing system and reduce cost.

Although examples are described with reference to a build platform for an additive manufacturing machine, examples are not limited to additive manufacturing but may be implemented in other devices and for other applications. The examples shown and described illustrate but do not limit the scope of the patent, which is defined in the Claims following this Description.

As used in this document, “suspend” means to suspend something above a support or below a support and, accordingly, the “suspenders” on which a thing is suspended may hang from the support or sit atop the support; and “transparent” means transparent or translucent.

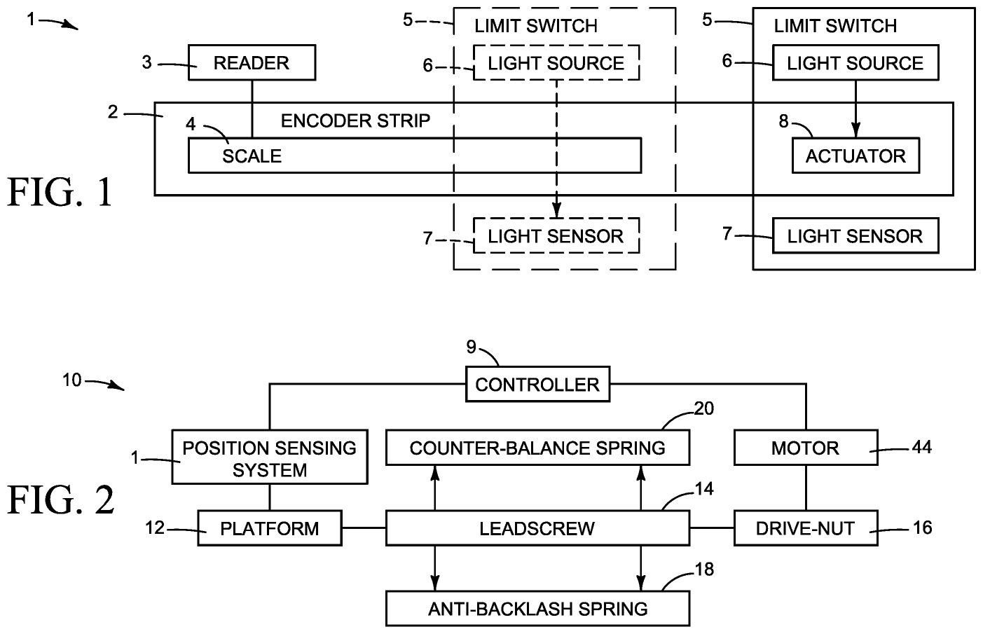

FIG. 1 is a block diagram illustrating one example of a position sensing system 1 such as might be used to help control the position of a build platform in an additive manufacturing machine. FIG. 2 is a block diagram illustrating an example position sensing system 1 from FIG. 1 implemented in a platform lift 10 for an additive manufacturing machine. Referring first to FIG. 1, an optical position sensing system 1 includes a linear encoder strip 2, an optical reader 3 to read a scale 4 on encoder strip 2, and an optical limit switch 5. An encoder strip 2 with a scale 4 and reader 3 are commonly referred to as “linear encoder.” Reader 3 includes a light source and a light sensor to detect markings on scale 4 and to generate corresponding signals indicating position along scale 4.

Limit switch 5 includes a light source 6, a light sensor 7 to sense light from source 6, and an actuator 8 on encoder strip 2 to block light from source 6 to sensor 7 and, thus, activate the switch. One or the other, or both, of encoder strip 2 and limit switch 5 move with respect to one another through positions in which scale 4 is between light source 6 and light sensor 7, shown in dashed lines in FIG. 1, and actuator 8 is between source 6 and sensor 7, shown in solid lines in FIG. 1. Scale 4 is not detectable by limit switch 5 and so does not activate the switch when scale 4 passes between light source 6 and light sensor 7. In one example, actuator 8 and encoder strip 2 are integrated into a single continuous strip of material. In another example, actuator 8 is a separate part attached to encoder strip 2.

FIG. 2 is a block diagram illustrating one example of a lift 10 to raise and lower a platform 12, such as might be used in a build unit for an additive manufacturing machine, including a platform position sensing system 1 from FIG. 1. Referring to FIG. 2, lift 10 includes a rotationally stationary leadscrew 14 operatively connected to platform 12 and a translationally stationary drive nut 16 to drive leadscrew 14 up and down. “Rotationally stationary” and “translationally stationary” refer to the operational relationship between leadscrew 14 and drive nut 16. During the operation of lift 10, leadscrew 14 does not rotate and drive nut 16 does not move up and down. Thus, rotating drive nut 16 around leadscrew 14 drives leadscrew 14 linearly up and down (referred to as translation), depending on the direction of rotation of nut 16. “Rotationally stationary” and “translationally stationary” do not mean the parts cannot be rotated or translated in other contexts, for example during shipping and handling.

Lift 10 also includes an anti-backlash spring 18 to apply a continuous downward force to leadscrew 14 and a counter-balance spring 20 to apply a continuous upward force to leadscrew 14. In one example, springs 18 and 20 are configured so that, excluding forces exerted on leadscrew 14 by drive nut 16, the total downward forces acting on leadscrew 14 are greater than the total upward forces acting on leadscrew 14 throughout a full range of motion, and by a consistent margin so that the net anti-backlash force of leadscrew 14 on drive nut 16 stays within a desired range. Thus, for example, in a build unit for additive manufacturing, as leadscrew 14 is driven down to lower platform 12, the downward force of anti-backlash spring 18 decreases and the upward force of counter-balance spring 20 increases to compensate for the weight of each layer of build material added to platform 12 at each increment of lowering.

Lift 10 also includes a motor 44 to turn nut 16 incrementally to drive leadscrew 14 carrying platform 12 the desired distance down or up at the direction of a controller 9. Motor 44 may be implemented, for example, as a server motor or stepper motor. Position sensing system 1 is operatively connected between platform 12 and controller 9 to signal the position of platform 12 to controller 9. Controller 9 represents the programming, processing and associated memory resources, and the other electronic circuitry and components to control the operation of motor 44 using feedback from position sensing system 1. Controller 9 may be implemented as a local motor controller or as part of a system or machine controller.

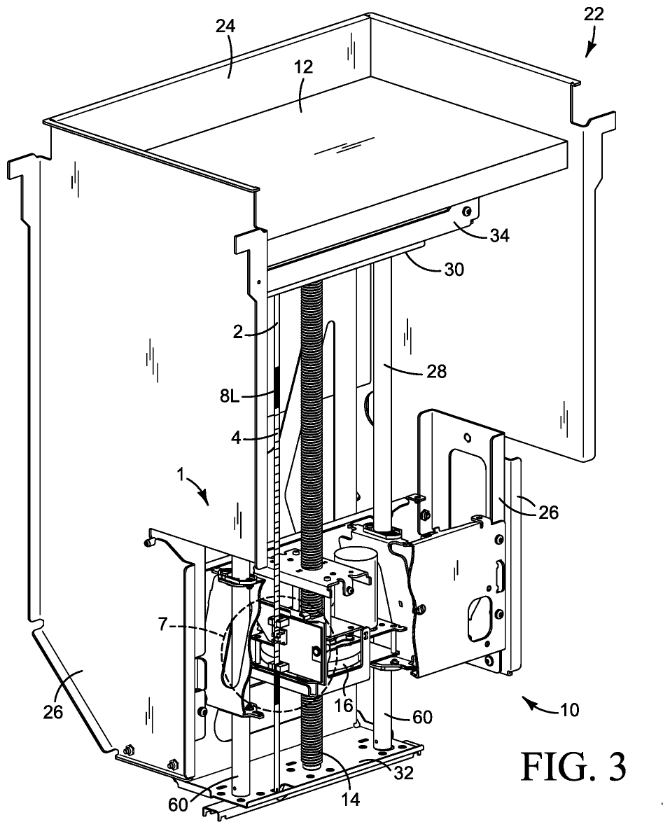

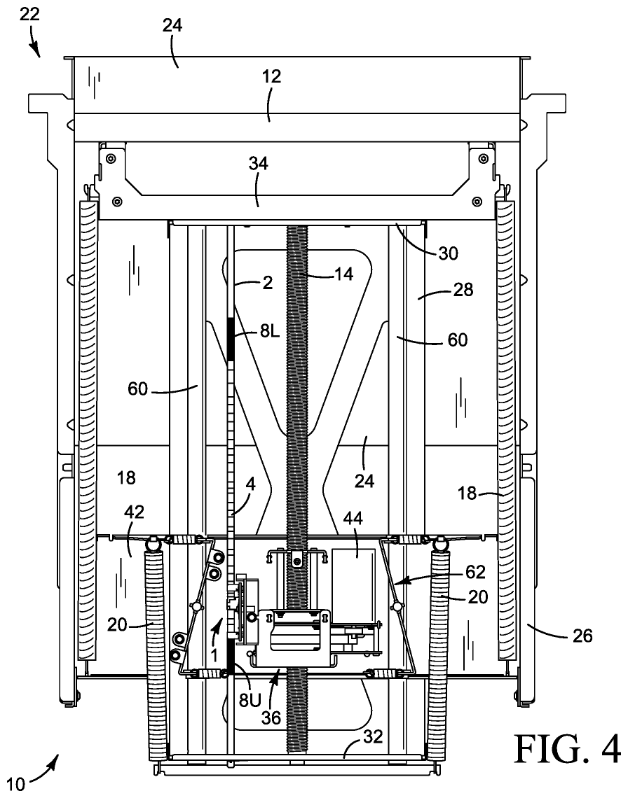

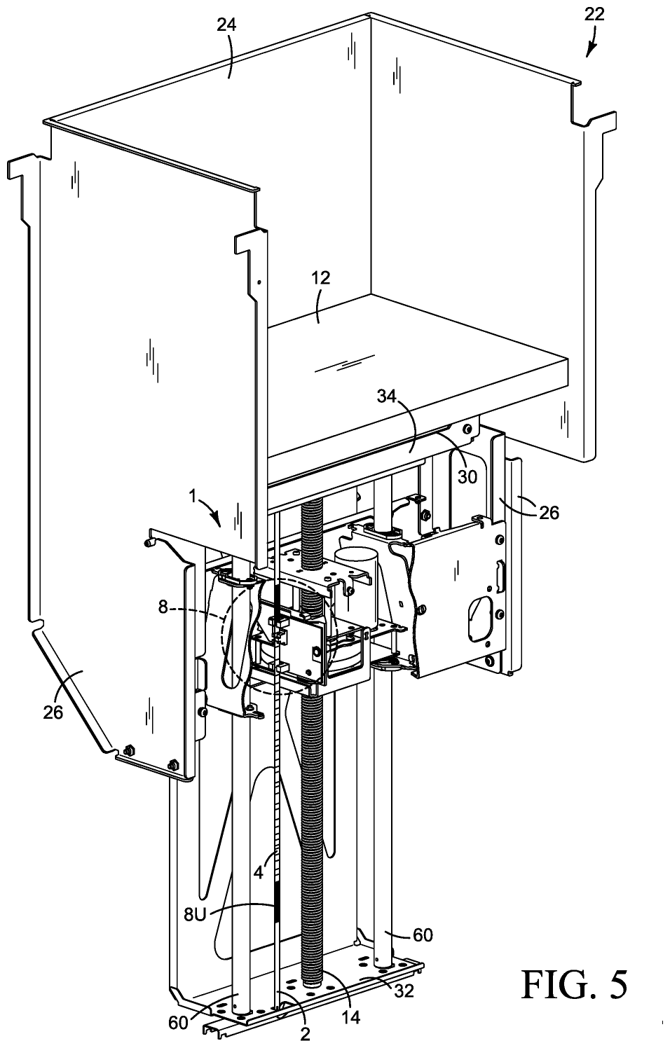

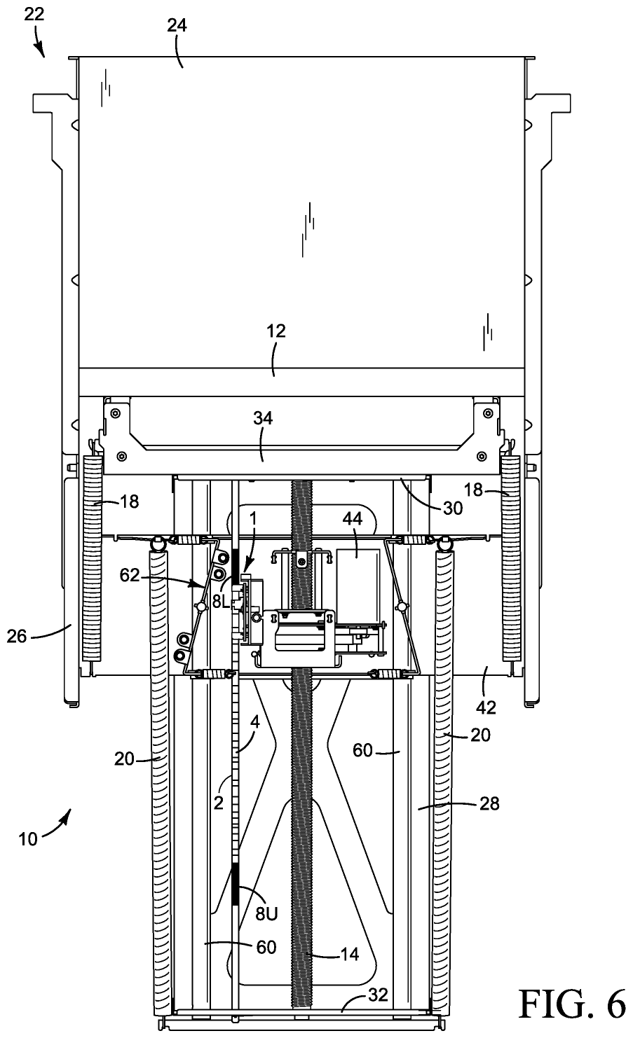

FIGS. 3-6 illustrate one example of a build unit 22 for an additive manufacturing machine. FIGS. 3 and 4 show unit 22 with build platform 12 in a raised position. FIGS. 5 and 6 show unit 22 with build platform 12 in a lowered position. Referring to FIGS. 3-6, build unit 22 includes platform 12 connected to a lift 10, and a container 24 surrounding platform 12 to contain build material on platform 12 during manufacturing. The front panel of container 24 is omitted from FIGS. 3-6 to show parts that would otherwise be hidden from view. Container 24 is affixed to or integrated into a stationary chassis 26 that supports the lift components in an additive manufacturing machine. The front panel of chassis 26 is omitted from FIGS. 3-6 to show parts that would otherwise be hidden from view. Although it is expected that build unit 22 usually will be implemented as a stand-alone unit with lift chassis 26 mounted into the machine chassis, other suitable implementations are possible. Platform 12 sits atop a frame 28 that moves up and down with leadscrew 14 relative to chassis 26. In this example, a single leadscrew 14 is attached to and extends between an upper part 30 of frame 28 and a lower part 32 of frame 28. Platform 12 is mounted to a bracket 34 attached to frame upper part 30.

A pair of anti-backlash springs 18 extend between the upper part 30 of frame 28 and chassis 26 on opposite sides of leadscrew 14. Anti-backlash springs 18 and counter-balance springs 20 are omitted from the isometric views of FIGS. 3 and 5. Two pair of counter-balance springs 20 extend between the lower part 32 of frame 28 and chassis 26 on opposite sides of leadscrew 14. Although it is expected that the use of two pair of counter-balance springs 20 will enable greater adaptability for applying counter-balance forces, a single pair of counter-balance springs 20 may be used. In this example, counter-balance springs 20 are positioned inboard from anti-backlash springs 20, closer to leadscrew 14 and drive nut 16. Each pair of counter-balance springs 20 are attached to the front and rear chassis panels 42, respectively. Only the rear chassis panel 42 is shown in FIGS. 4 and 6. Consequently, the tops of the forward pair of counter-balance springs 20 that are connected to the missing front chassis panel appear unattached in FIGS. 2-4.

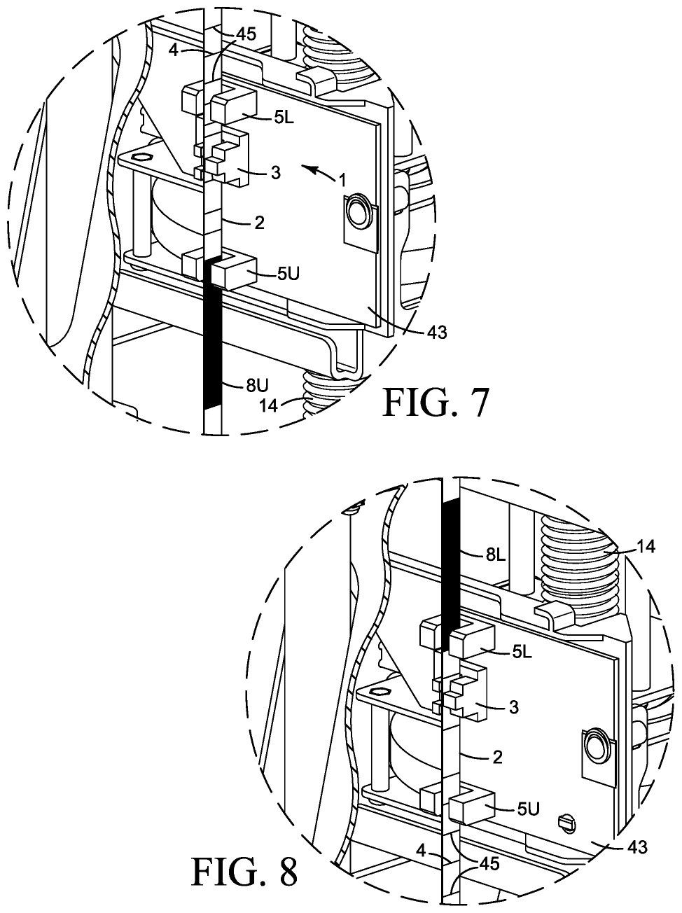

Referring now also to the detail views of FIGS. 7 and 8, an encoder strip 2 is attached to frame 28 at upper part 30 and lower part 32. Thus, encoder strip 2 moves up and down with frame 28 and platform 12 (attached to frame 28) between upper part 30 and lower part 32. Encoder strip 2 includes a scale 4 along a middle part of strip 2, an upper position actuator 8U near the bottom of strip 2 and a lower position actuator 8L near the top of strip 2. An optical reader 3 is mounted chassis 26 along with an upper optical limit switch 5U and a lower optical limit switch 5L, for example as part of a printed circuit board assembly (PCA) 43 attached to brackets 54. “Upper” and “lower” in this context refers to the position of platform 12, not the position of actuators 8U, 8L on strip 2 or switches 5U, 5L on PCA 43. A local motor or system controller 9 (FIG. 2) may also be integrated into PCA 43 along with reader 3 and limit switches 5U and 5L.

The middle part of encoder strip 2 between actuators 8L, 8U is transparent with opaque markings 45 along scale 4. Markings 45 are readable by reader 3 but not detectable by limit switches 5L, 5U. Thus, markings 45 do not activate either switch 5L, 5U as scale 4 passes the switches. For one example, black scale lines 45 about 0.0635 mm thick and spaced apart about 0.0635 mm are readable by an encoder reader 3 but are not detectable by an optical limit switch 5L, 5U, while still signaling sufficiently precise information to accurately control the position of platform 12. Upper and lower actuators 8U, 8L may be implemented, for example, as black patches in or on encoder strip 2 at each end of scale 4 at locations signaling the approach of the physical limit of travel of platform 12 or other desired stopping location. The physical limit of travel of platform 12 is commonly referred to as a “hard stop.” Stopping platform 12 before the physical limit, usually less abruptly than a stop at the physical limit, is commonly referred to as a “soft stop.”

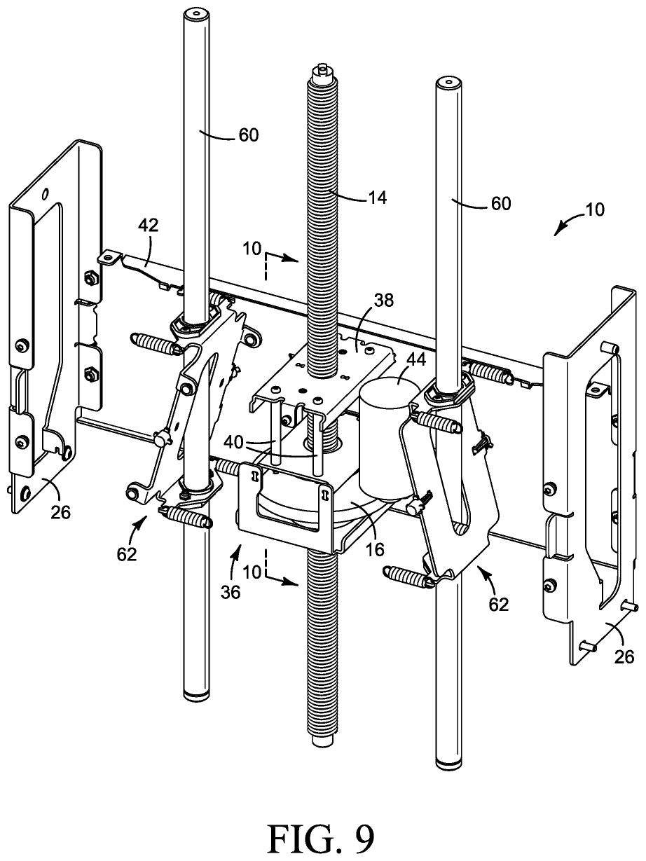

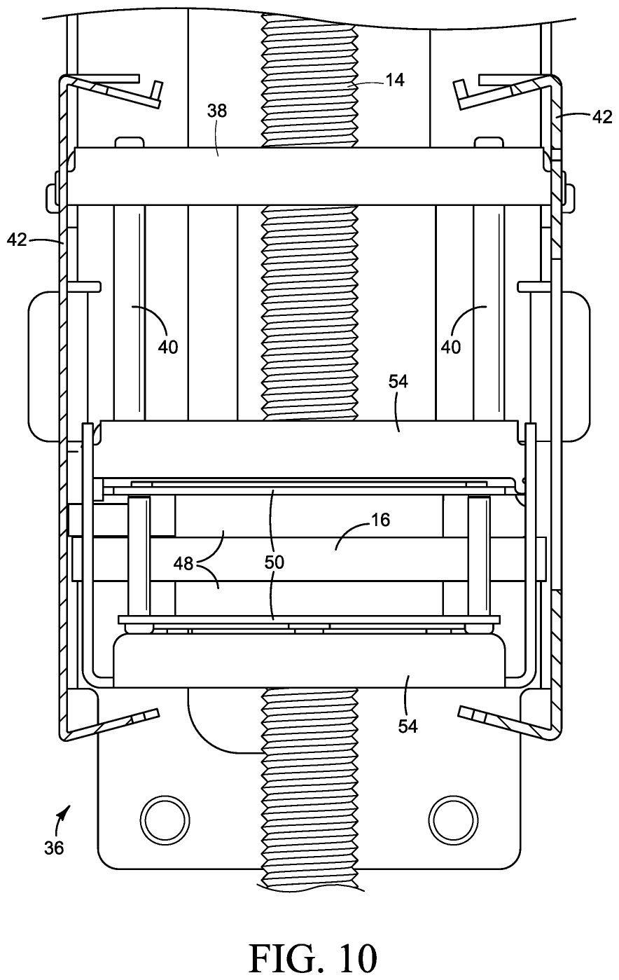

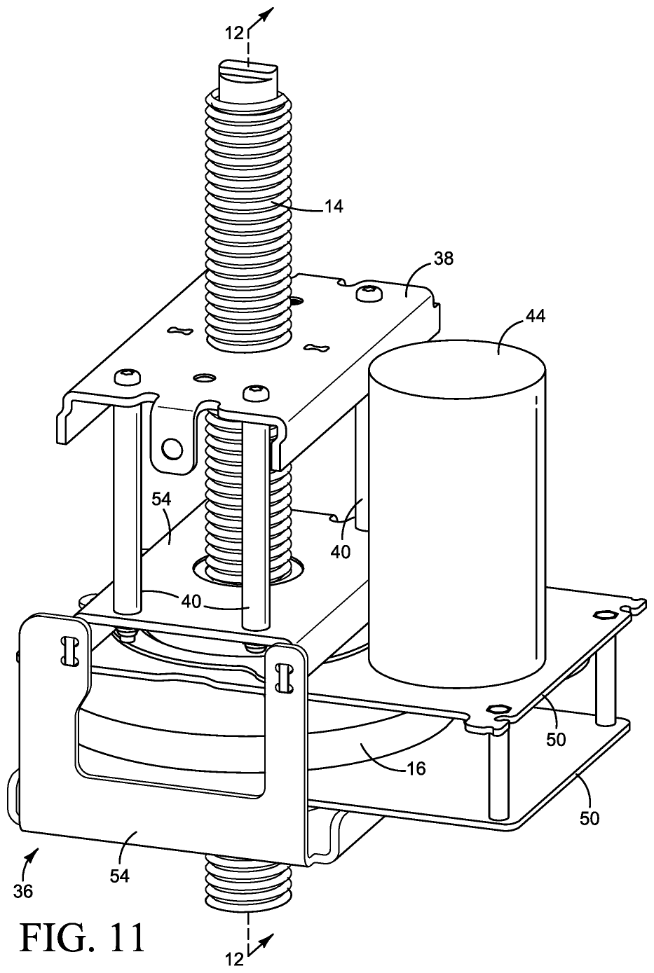

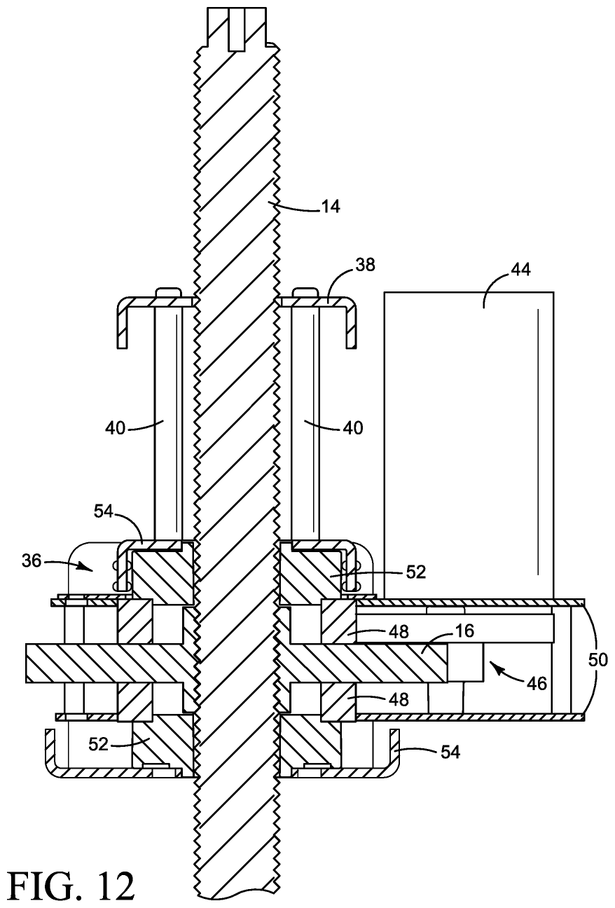

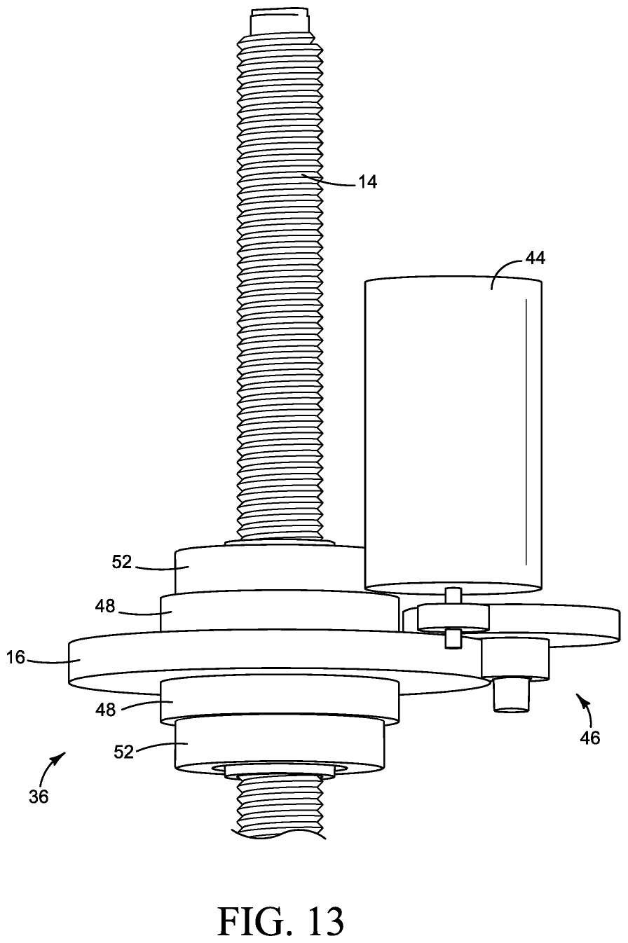

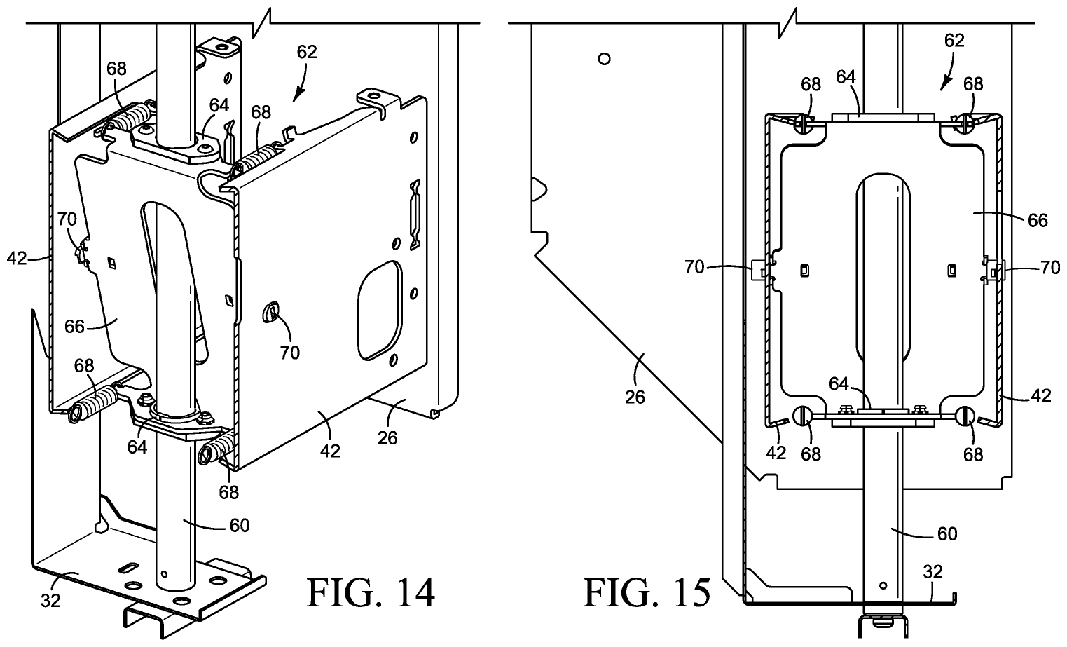

Referring now also to the detail views of FIGS. 9-13, leadscrew 14 (and thus frame 28 and platform 12) is mounted to chassis 26 through a drive nut 16. Drive nut 16 is suspended from chassis 26 in a drive assembly 36. In this example, drive assembly 36 hangs from a bracket 38 on suspenders 40 between chassis panels 42 such that drive nut 16 is suspended from above. In other examples, drive nut 16 may be supported from below on suspenders that sit atop a bracket or other support. The front chassis panel 42 is omitted from FIG. 9 to show parts that would otherwise be hidden from view. Suspending drive assembly 36 from or on chassis 26 allows the drive assembly and thus nut 16 to move laterally, introducing compliance into the drive system to accommodate any misalignment with respect to leadscrew 14.

Drive assembly 36 includes drive nut 16 operatively connected to a drive motor 44 through a gear train 46. Drive nut 16 is implemented as a gear nut with internal threads that engage leadscrew 14 and external teeth (not shown) that engage gear train 46. Gears are depicted without teeth in the figures. Drive nut 16 is supported between thrust bearings 48, which are sandwiched between plates 50 and spacers 52 and mounted to brackets 54. As noted above, the entire drive assembly 36 is suspended from bracket 38 on suspenders 40.

In operation, motor 44 is energized to turn nut 16 through gear train 46 incrementally to drive leadscrew 14 carrying platform 12 the desired distance down or up. As platform 12 moves down, anti-backlash extension springs 18 contract to reduce their downward force on leadscrew 14 and counter-balance extensions springs 20 extend to increase their upward force on leadscrew 14, as best seen by comparing the extension of springs 18 and 20 in FIGS. 4 and 6. The changing forces compensate for the weight of build material added to platform 12 at each increment of lowering during the layer by layer additive manufacturing process.

Reader 3 in position sensing system 1 reads scale 4 to signal the position of platform 12 to controller 9 (FIG. 2). Controller 9 can then start, stop, or otherwise vary the rotation of motor 44 to position platform 12 at the desired locations during a build operation. When platform 12 reaches a lower limit of travel, shown in FIGS. 5, 6 and 8, actuator 5L blocks the light to sensor 7 (FIG. 1) in switch 5L to activate the switch, signaling controller 9 that platform 12 has reached the lower limit. When platform 12 reaches an upper limit of travel, shown in FIGS. 3, 4 and 7, actuator 5U blocks the light to sensor 7 (FIG. 1) in switch 5U to activate the switch, signaling controller 9 that platform 12 has reached the upper limit.

Referring now to FIGS. 3-6, 12 and 13, lift 10 also includes a pair of guide rods 60 connected between the upper part 30 of frame 28 and the lower part 32 of frame 28 on opposite sides of leadscrew 14. Each guide rod 60 is oriented parallel to leadscrew 14 and mounted to chassis 26 through a bearing assembly 62. Bearing assembly 62 constrains each guide rod 60 laterally while allowing the guide rod to slide up and down with leadscrew 14 and frame 26, to help keep leadscrew 14 and frame 26 properly aligned vertically. In this example, each bearing assembly 62 includes a pair of bearings 64 spaced apart from one another vertically and connected by a diagonally oriented plate 66 that straddles a respective guide rod 60. Each connecting plate 66 is support between front and rear chassis panels 42 on a pivot 70 at or near the center of the plate. Springs 68 connected between each end of plate 66 and chassis panels 42 at a point vertically near each bearing 62 apply a biasing force to the guide rod in one direction at the top bearing and in the opposite direction at the bottom bearing, to help prevent guide rods 60 from titling out of vertical alignment.

The examples shown in the figures and described above illustrate but do not limit the patent, which is defined in the following Claims.

“A”, “an” and “the” used in the claims means one or more.

1. An optical position sensing system, comprising:
a linear encoder strip;
an optical limit switch having an actuator on the encoder strip to activate the limit switch; and
an optical reader to read the encoder strip.

2. The system of claim 1, where the actuator is integral to the encoder strip.

3. The system of claim 1, where the actuator is attached to the encoder.

4. The system of claim 1, comprising:
a motor; and
a controller operatively connected to the motor, the optical limit switch, and the optical reader, the controller programmed to vary a rotation of the motor based on signals from the optical limit switch and the optical reader.

5. An optical position sensing system, comprising:
a linear encoder strip having an opaque first part, an opaque second part, a transparent third part between the first and second parts, and a scale on the third part;
a first optical detector to detect the opaque first part but not the scale;
a second optical detector to detect the opaque second part but not the scale; and
an optical reader between the first and second detectors to read the scale.

6. The system of claim 5, where the first, second and third parts of the encoder strip are integrated into a single continuous strip of material.

7. The system of claim 5, where:
the third part of the encoder strip is part of a single continuous strip of material; and
the first and second parts of the encoder strip are separate parts attached to the strip of material.

8. The system of claim 5, comprising:
a stepper motor; and
a controller operatively connected to the motor, the first optical detector, the second optical detector, and the optical reader, the controller programmed to start and stop the motor based on signals from the optical detectors and the optical reader.

9. The system of claim 5, where the reader and detectors are stationary and the strip is movable past the reader and the detectors.

10. A platform lift, comprising:
a rotationally stationary leadscrew to support a platform;
a rotatable nut to drive the leadscrew up and down through a range of motion;
a first spring to apply a continuous downward force to the leadscrew throughout the range of motion;
a second spring to apply a continuous upward force to the leadscrew throughout the range of motion;
a linear encoder strip operatively connected to the leadscrew, the encoder strip having a scale thereon to indicate a vertical position of the leadscrew;
an optical reader to read the scale;
a first optical limit switch to signal an upper limit of the vertical position of the leadscrew, the first limit switch having a first actuator on the encoder strip to activate the first limit switch; and
a second optical limit switch to signal a lower limit of the vertical position of the leadscrew, the second limit switch having a second actuator on the encoder strip to activate the second limit switch.

11. The lift of claim 10, where:
the encoder strip includes an opaque first part, an opaque second part, a transparent third part with the scale between the first part and the second part;
the first actuator includes the opaque first part of the encoder strip and the first limit switch includes a first optical detector to detect the opaque first part but not the scale, to activate the first limit switch; and
the second actuator includes the opaque second part of the encoder strip and the second limit switch includes a second optical detector to detect the opaque second part but not the scale, to activate the second limit switch.

12. The lift of claim 11, where:
the encoder strip is movable with the lead screw; and
the reader and limit switches are stationary.

13. The lift of claim 12, comprising:
a motor; and
a controller operatively connected to the motor, the limit switches, and the reader, the controller programmed to vary a rotation of the motor based on signals from the limit switches and the reader.

14. The lift of claim 13, where:
the first spring is to apply a continuous downward force to the leadscrew through the range of motion that decreases in magnitude when the leadscrew moves down and increases in magnitude when the leadscrew moves up; and
the second spring is to apply a continuous upward force to the leadscrew through the range of motion that increases in magnitude when the leadscrew moves down and decreases in magnitude when the leadscrew moves up.

15. The lift of claim 14, where the first and second springs are to apply their respective forces so a net downward force acting on the leadscrew is greater than a net upward force acting on the leadscrew throughout the range of motion, excluding forces exerted on the leadscrew by the nut.
